(19) United States
(12) Patent Application Publication
(10) Pub. No.: US 2020/0406441 A1
(43) Pub. Date: Dec. 31, 2020

(54) PERCUSSION TOOL

(71) Applicant: MILWAUKEE ELECTRIC TOOL CORPORATION, Brookfield, WI (US)

(72) Inventors: Alexander Krug, Leutenbach (DE); Zbynêk Kadlec, Prestice (CZ); Günter Karg, Winnenden (DE); Andrew Delmar Van Hoorn, Menomonee Falls, WI (US); Kevin Gee, Milwaukee, WI (US)

(21) Appl. No.: 17/018,117

(22) Filed: Sep. 11, 2020

Related U.S. Application Data
(63) Continuation of application No. 16/164,000, filed on Oct. 18, 2018, now Pat. No. 10,814,468.
(60) Provisional application No. 62/650,745, filed on Mar. 30, 2018.
(60) Provisional application No. 62/574,838, filed on Oct. 20, 2017.

(51) Int. Cl. B25D 17/08; B25D 17/24; B25D 11/12; B25D 11/04; B25D 11/06; B25D 17/02; B25D 17/04

(52) U.S. Cl. CPC B25D 17/082; B25D 17/24; B25D 11/125; B25D 11/04; B25D 2250/095; B25D 17/02; B25D 17/04; B25D 2250/385; B25D 11/068

(57) ABSTRACT

A percussion tool is used for performing a chiseling operation on a workpiece with a chisel. The percussion tool comprises a housing including a cylinder portion, a tool holder coupled to the cylinder portion for holding the chisel, and a percussion mechanism including a striker supported for reciprocation in the cylinder portion. The percussion mechanism is configured to impart repeated axial impacts to the chisel with the striker. The percussion tool further comprises a flange between the cylinder portion and the tool holder. Movement of the chisel within the tool holder toward the percussion mechanism is stopped by the flange.

### CROSS-REFERENCE TO RELATED APPLICATIONS

This application is a continuation of co-pending U.S. patent application Ser. No. 16/164,000 filed on Oct. 18, 2018, which claims priority to U.S. Provisional Patent Application No. 62/574,838 filed on Oct. 20, 2017, and U.S. Provisional Patent Application No. 62/650,745 filed on Mar. 30, 2018, the entire contents of all of which are incorporated herein by reference.

### FIELD OF THE INVENTION

The present invention relates to percussion tools, and more particularly to tool holders for holding chisels for use with a percussion tool.

### BACKGROUND OF THE INVENTION

Percussion tools can use tool holders to hold a chisel. A percussion mechanism of the percussion tool can include a striker to impart repeated axial impacts to the chisel, which in turn repeatedly impacts a workpiece or surface. The chisel can be inserted into the tool holder so as to abut the striker in order to receive the repeated axial impacts.

### SUMMARY OF THE INVENTION

The present invention provides, in one aspect, a percussion tool for performing a chiseling operation on a workpiece with a chisel. The percussion tool comprises a housing, an electric motor positioned within the housing, and a percussion mechanism driven by the motor and including a striker supported for reciprocation relative to the housing along a longitudinal axis. The percussion tool further comprises a tool holder coupled to the housing and including a rotatable handle having a rod that rotates with the handle within the tool holder. The chisel is securable in and removable from the tool holder. The chisel has a longitudinal groove that is substantially parallel with the longitudinal axis. When the chisel is secured in the tool holder, the chisel is permitted to axially reciprocate within the tool holder in response to receiving repeated axial impacts from the striker. The handle is moveable between a first position, in which the rod is received in the groove and the chisel is secured in the tool holder, and a second position, in which the rod is removed from the groove and the chisel is removable from the tool holder. When the handle is in the second position, an acute angle is defined between a first reference plane defined by the handle and a second reference plane that is perpendicular to the longitudinal axis. The acute angle is 10 degrees or less.

The present invention provides, in another aspect, a percussion tool for performing a chiseling operation on a workpiece with a chisel. The percussion tool comprises a housing, an electric motor positioned within the housing, and a percussion mechanism driven by the motor and including a striker supported for reciprocation relative to the housing along a longitudinal axis. The percussion tool further comprises a tool holder coupled to the housing and including a rotatable handle having a cylindrical rod defining an axis of rotation of the handle. The rod has a recessed portion and an opposite arcuate portion defined by a circumference of the rod. The chisel is securable in and removable from the tool holder. The chisel has a longitudinal groove that is substantially parallel with the longitudinal axis. When the chisel is secured in the tool holder, the chisel is permitted to axially reciprocate within the tool holder in response to receiving repeated axial impacts from the striker. The handle is moveable between a first position, in which the arcuate portion is received in the groove and the chisel is secured in the tool holder, and a second position, in which the arcuate portion is removed from the groove, the recessed portion is in facing relationship with the groove, and the chisel is removable from the tool holder. The arcuate portion defines an angle of 110 degrees or less along the circumference of the rod with respect to the axis of rotation of the handle.

The present invention provides, in yet another aspect, a percussion tool for use with a chisel. The percussion tool comprises a housing including a cylinder portion and a tool holder coupled to the cylinder portion for holding the chisel. The percussion tool further comprises a percussion mechanism including a striker supported for reciprocation in the cylinder portion, the percussion mechanism configured to impart repeated axial impacts to the chisel via the striker. The percussion tool also comprises a flange between the cylinder portion and the tool holder, wherein movement of the chisel within the tool holder toward the percussion mechanism is stopped by the flange.

Other features and aspects of the invention will become apparent by consideration of the following detailed description and accompanying drawings.

### BRIEF DESCRIPTION OF THE DRAWINGS

FIG. 1 is a perspective view of a percussion tool in accordance with an embodiment of the invention.

FIG. 2 is a cross-sectional view of the percussion tool of FIG. 1.

FIG. 3 is a perspective view of a chisel for use with the percussion tool of FIG. 1.

FIG. 4 is a perspective view of a different chisel for use with the percussion tool of FIG. 1.

FIG. 5 is a cross-sectional view of portion of the percussion tool of FIG. 1 with a portion of the chisel of FIG. 3 inserted into a tool holder of the percussion tool.

FIG. 6 is a cross-sectional view of a portion of the percussion tool of FIG. 1 with a portion of the chisel of FIG. 4 inserted into the tool holder of the percussion tool.

FIG. 7 is a cross-sectional view of a portion of a percussion tool in accordance with yet another embodiment of the invention, illustrating a portion of the chisel of FIG. 3 inserted into a tool holder of the percussion tool.

FIG. 8 is a cross-sectional view of a portion of the percussion tool of FIG. 7 with a portion of the chisel of FIG. 4 inserted into the tool holder of the percussion tool.

FIG. 9 is a top perspective view of another embodiment of a handle of a tool holder for use with the percussion tool of FIG. 1.

FIG. 10 is a bottom perspective view of the handle of FIG. 9.

FIG. 11 is a cross-sectional view of another embodiment of a tool holder including the handle of FIG. 9, with portions removed.

FIG. 12 is a cross-sectional view of another embodiment of a tool holder for use with the percussion tool of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

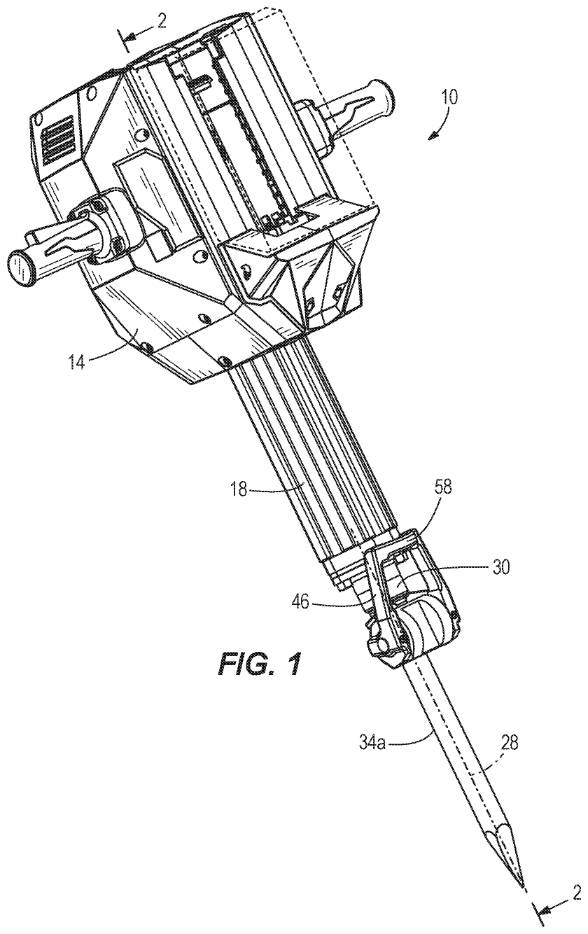

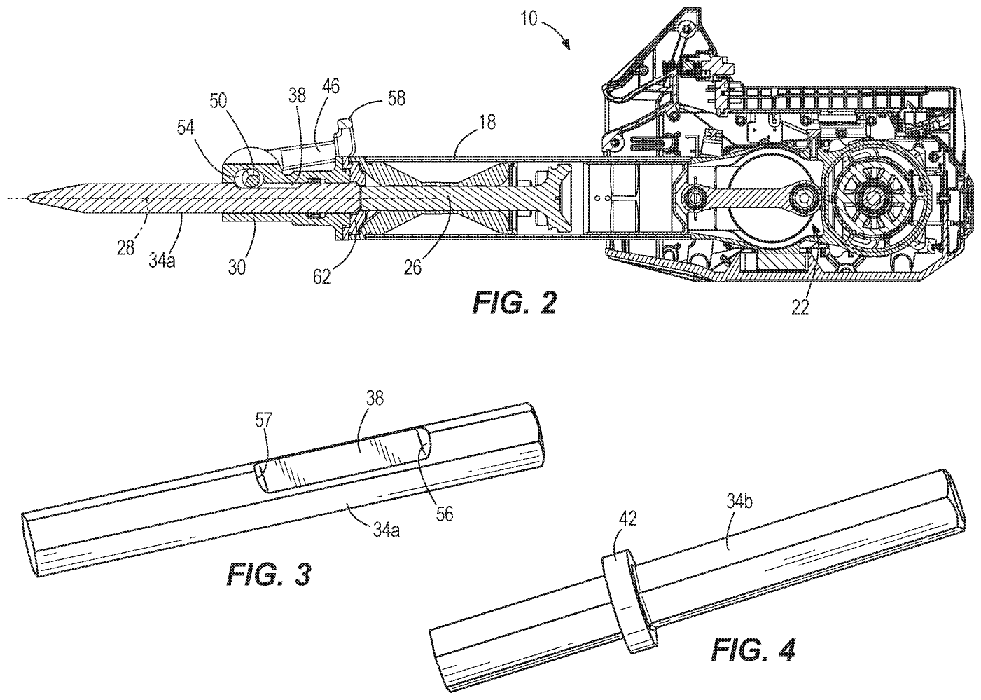

With reference to FIGS. 1 and 2, a percussion tool 10, such as a breaker, includes a housing 14 having a cylinder portion 18. A percussion mechanism 22 is disposed in the housing 10 and can be any suitable percussion mechanism, including but not limited to pneumatic, hydraulic, motor-driven, or electromagnetic. The percussion mechanism 22 includes a striker 26 supported for reciprocation along a longitudinal axis 28 in the cylinder portion 18.

A tool holder 30 for holding a chisel 34a, 34b is coupled to the cylinder portion 18. As will be explained in further detail below, the tool holder 30 is adapted to hold a variety of chisels. For example, the tool holder 30 is adapted to hold a chisel 34a with a radially inward-extending longitudinal groove 38 as shown in FIG. 3. The groove 38 is parallel with the longitudinal axis 28 when the chisel 34a is received in the tool holder 30. The tool holder 30 is also adapted to hold a chisel 34b that has a radially outward-extending flange 42 instead of a longitudinal groove, as shown in FIG. 4. The percussion mechanism 22 is configured to impart repeated axial impacts to the chisel 34a, 34b via the striker 26, so that a breaking operation or chiseling operation may be performed on a workpiece or surface.

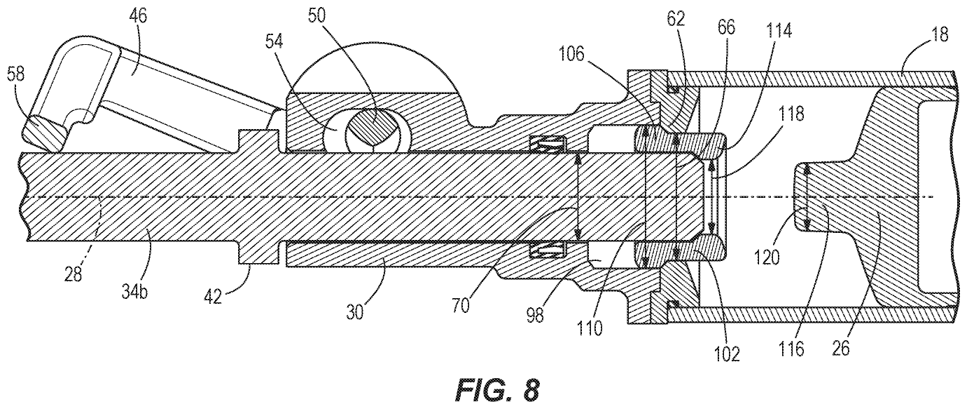

The tool holder 30 includes a rotatable handle 46 that can rotate between a first position shown in FIGS. 1, 2, 5 and 7, and a second position shown in FIGS. 6 and 8. The handle 46 includes an eccentric pin 50 rotatable therewith within a lateral recess 54 of the tool holder 30. If an operator elects to use chisel 34a with the percussion tool 10, rotation of the handle 46 to the first position causes the eccentric pin 50 to move radially inward within the recess 54, thereby engaging the longitudinal groove 38. Thus, if the operator tips the percussion tool 10 in such a manner that the chisel 34a might be caused to fall out of the tool holder 30, the eccentric pin 50 will contact a rear end 56 of the longitudinal groove 38 to prevent the chisel 34a from falling out. During operation of the percussion tool 10, as the striker 26 imparts axial blows to the chisel 34a along the longitudinal axis 28, the chisel 34a reciprocates within the tool holder 30 between forward and rearward positions where the eccentric pin 50 is maintained between the rear end 56 of the longitudinal groove and an opposite front end 57 of the longitudinal groove 38.

The handle 46 also includes a finger 58. If an operator elects to use chisel 34b with the percussion tool 10, the handle 46 is rotated to the second positon in which the finger 58 abuts the chisel 34b. As shown in FIGS. 6 and 8, rotation of the handle 46 to the second position also causes the eccentric pin 50 to move radially outward in the recess 54, so as to avoid interfering with chisel 34b within the tool holder 30, because chisel 34b does not have a longitudinal groove. Thus, if the operator tips the percussion tool 10 in such a manner that the chisel 34b might be caused to fall out of the tool holder 30, the finger 58 will contact the radially outward-extending flange 42 and prevent the chisel 34b from falling out.

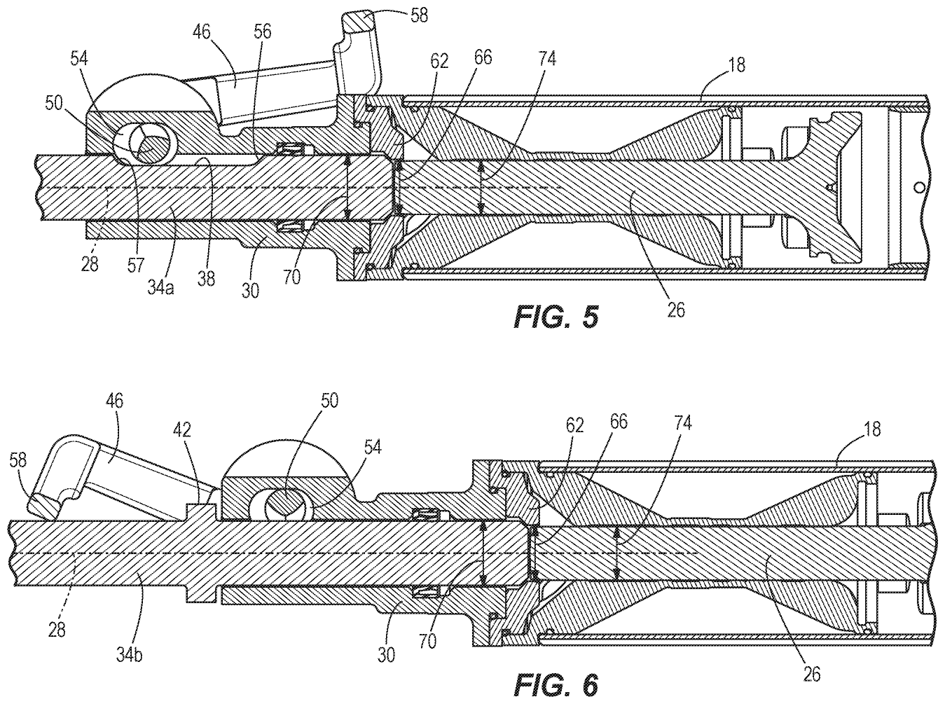

A radially inward-extending flange 62 with an inner diameter 66 is located between the cylinder portion 18 and the tool holder 30. In a first embodiment of the invention shown in FIGS. 5 and 6, the inner diameter 66 of the flange 62 is less than an outer diameter 70 of either of the chisels 34a, 34b, and greater than an outer diameter 74 of the striker 26. Thus, when an operator inserts either of the chisels 34a, 34b into the tool holder 30, movement of the chisels 34a, 34b within the tool holder 30 toward the percussion mechanism 22 is stopped in response to the chisels 34a, 34b abutting the flange 62 (as shown in each of FIGS. 5 and 6).

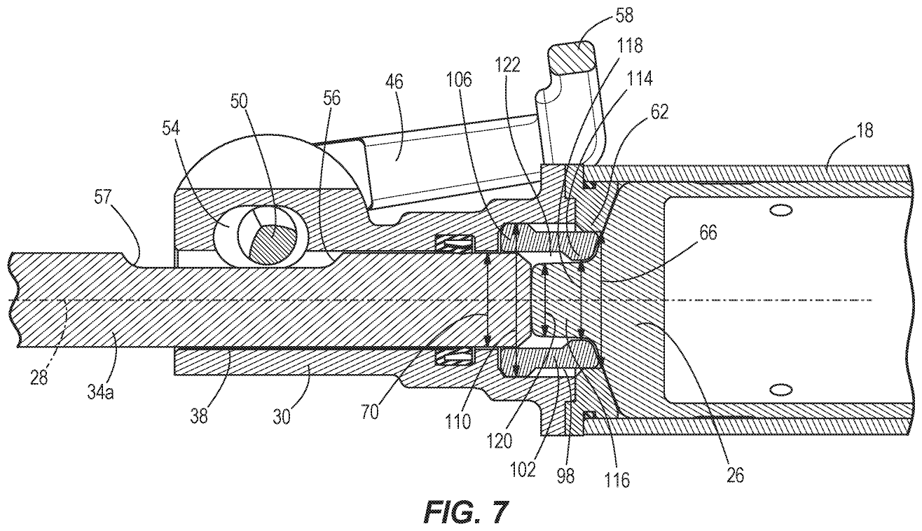

In another embodiment of a percussion tool shown in FIGS. 7 and 8, with like features being identified with like reference numerals, the tool holder 30 includes a recess 98 to accommodate an axially moveable sleeve 102. The sleeve 102 has a first end 106 with a first end outer diameter 110 that is greater than the inner diameter 66 of the flange 62. The sleeve 102 has an opposite second end 114 with a second end inner diameter 118 that is less than the outer diameter 70 of each of the chisels 34a, 34b. A striking end 116 of the striker 26 has an outer diameter 120 that is nominally less than the inner diameter 118 of the second end 114 of the sleeve 102, so that the striking end 116 may pass through the sleeve 102 and strike the chisels 34a, 34b. The chisels 34a, 34b axially move within a hollow portion 122 of the sleeve 102. Thus, when an operator inserts either of the chisels 34a, 34b into the tool holder 30, movement of the chisels 34a, 34b within the tool holder 30 toward the percussion mechanism 22 is stopped in response to the chisels 34a, 34b abutting the second end 114 of the sleeve 102, and the first end 106 of the sleeve 102 abutting the flange 62 (as shown in FIG. 8).

The flange 62 limits the distance the chisels 34a, 34b can be inserted into the tool holder 30, thereby preventing damage to the percussion mechanism 22 and allowing the point of impact between the striker 26 and the chisels 34a, 34b to remain consistent. Also, regardless of which of the chisels 34a, 34b an operator selects, the same percussion tool 10 may be used because the tool holder 30 is adapted to hold a variety of chisels.

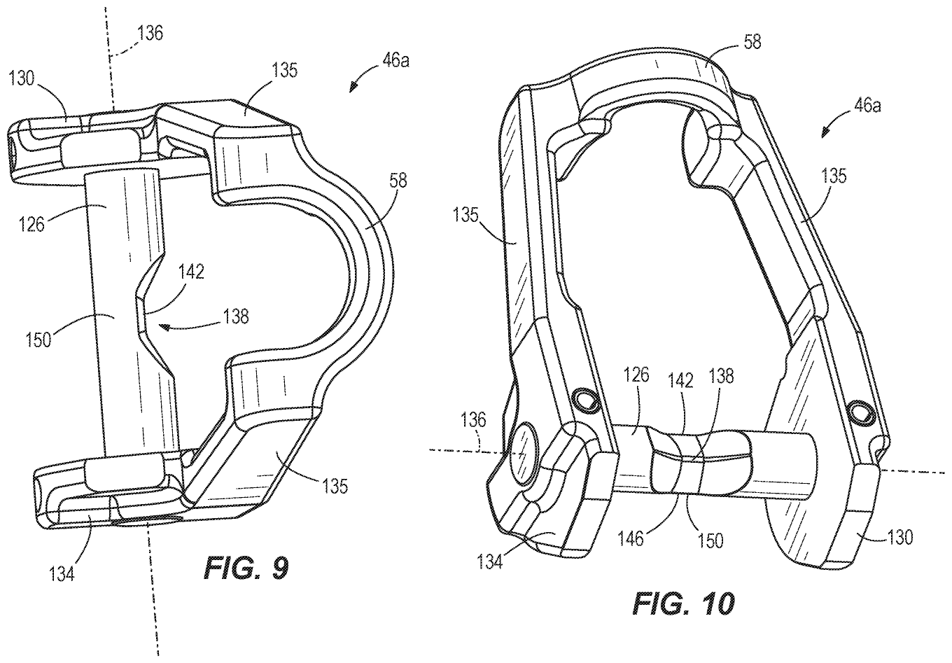

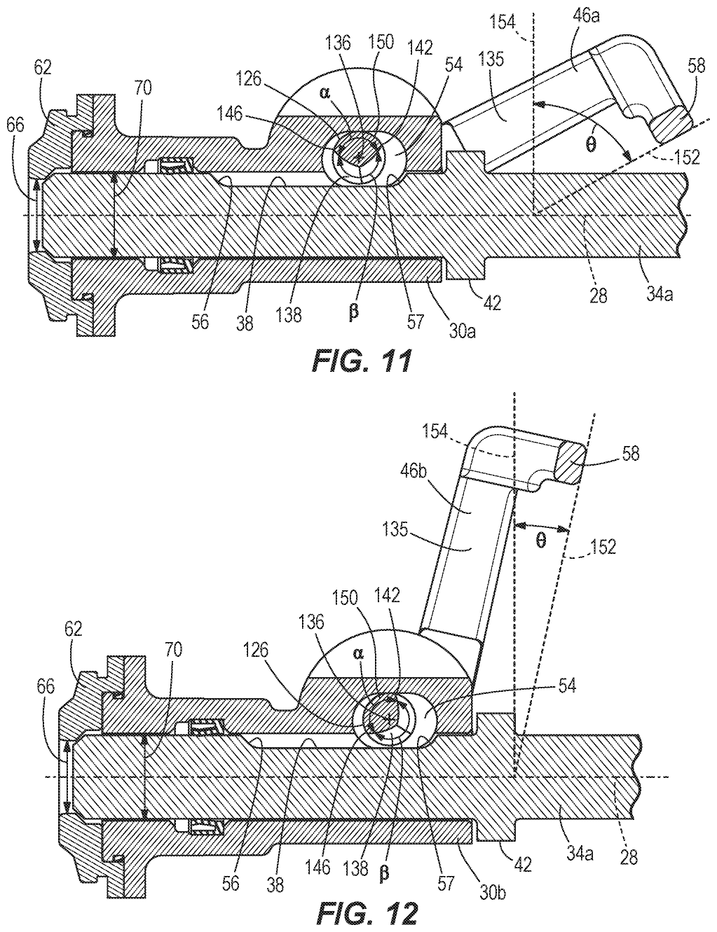

FIG. 11 illustrates another embodiment of a tool holder 30a for use with the breaker 10 of FIG. 1, with like components shown with like reference numerals. The tool holder 30a includes a handle 46a having a rod 126 extending between opposite ends 130, 134 of the handle 46a (see also FIGS. 9 and 10), two legs 135 respectively extending from the opposite ends 130, 134, and the finger 58 extending between the legs 135 and in a direction approximately perpendicular to the legs 135. The rod 126 extends through the recess 54 of the tool holder 30a and defines an axis of rotation 136 about which the handle 46a rotates with respect to the tool holder 30a. The rod 126 is cylindrical and has a recessed portion 138 defined between two edges 142, 146 on the circumference of the rod 126. Opposite the recess 138, an arcuate portion 150 is defined between the two edges 142, 146 along the circumference of the rod 126. As shown in FIG. 12, with respect to the axis of rotation 136, the arcuate portion 150 defines an angle α that is slightly less than 180 degrees about the circumference of the rod 126. Correspondingly, the recess 138 defines an angle β that is slightly more than 180 degrees.

If an operator elects to use chisel 34a with the tool holder 30a, rotation of the handle 46a to the first position causes rod 126 to rotate such that the arcuate portion 142 contacts the chisel 34a within the longitudinal groove 38. Thus, if the operator tips the percussion tool 10 in such a manner that the chisel 34a might be caused to fall out of the tool holder 30a, the arcuate portion 150 will contact the rear end 56 of the longitudinal groove 38 to prevent the chisel 34a from falling out. During operation of the percussion tool 10, as the striker 26 imparts axial blows to the chisel 34a along the longitudinal axis 28, the chisel 34a reciprocates within the tool holder 30a between forward and rearward positions where the arcuate portion 150 is maintained between the rear end 56 of the longitudinal groove 38 and the front end 57 of the longitudinal groove 38.

To release the chisel 34a, the operator must rotate the handle 46a from a first position (having an orientation relative to axis 28 similar to that shown in FIGS. 1 and 2) in which the arcuate portion 150 is located at least partially within the groove 38 of the chisel 34a to a second position shown in FIG. 11. Rotation of the handle 46a to the second position causes the rod 126 to rotate, thus rotating the arcuate portion 150 away from the longitudinal groove 38 and removing the arcuate portion 150 from the longitudinal groove 38 of the chisel 34a, and instead placing the recessed portion 138 in facing relationship with the longitudinal groove 38, thus allowing chisel 34a to be removed. As shown in FIG. 11, an angle θ is defined between a first reference plane 152 defined by handle 46a and a second reference plane 154 that is perpendicular to the longitudinal axis 28. In the embodiment of FIGS. 9-11, the angle θ is approximately 70 degrees. In the embodiment illustrated in FIG. 11, the first reference plane 152 is defined as tangent to the finger 58. In other embodiments, the first reference plane 152 could be defined as extending along the legs 135, and the second reference plane 154 would be shifted left, as viewed in FIG. 11. Regardless of where the reference plane 152 is defined on the handle 46a, if the handle 46a is rotated to a position intermediate the first and second positions, the first reference plane 152 would be co-planar with the second reference plane 154.

FIG. 12 illustrates another embodiment of a tool holder 30b for use with the breaker 10 of FIG. 1, with like components shown with like reference numerals. The tool holder 30b includes a handle 46b that is otherwise identical to the handle 46a except that the angle α defined by the arcuate portion 150 is approximately 110 degrees about the circumference of the rod 126. Thus, the recessed portion 138 defines an angle β that is approximately 250 degrees. To release the chisel 34a, the operator must rotate the handle 46b from a first position (having an orientation relative to axis 28 similar to that shown in FIGS. 1 and 2) in which the arcuate portion 150 is located at least partially within the groove 38 of the chisel 34a to a second position shown in FIG. 12. In this embodiment of the tool holder 30b, the angle θ defined between the finger 58 of handle 46b and the plane 154 is approximately 10 degrees. Because the arc length of the arcuate portion 142 has been reduced to approximately 110 degrees in the embodiment of FIG. 12, the operator does not need to rotate the handle 46b as far as in the embodiment of the tool holder 30a shown in FIG. 11 to release the chisel 34a (70 degrees beyond the second reference plane 154 with the tool holder 30a versus 10 degrees beyond the second reference plane 154 with the tool holder 30b). Such an arrangement makes it faster and easier for the operator to change the chisels 34a, 34b used in the tool holder 30b. In the embodiment illustrated in FIG. 12, the first reference plane 152 is defined as tangent to the finger 58. In other embodiments, the first reference plane 152 could be defined as extending along the legs 135, and the second reference plane 154 would be shifted left, as viewed in FIG. 12. Regardless of where the reference plane 152 is defined on the handle 46b, if the handle 46b were rotated to a position intermediate the first and second positions, the first reference plane 152 would be co-planar with the second reference plane 154.

Various features of the invention are set forth in the following claims.

What is claimed is:

1. A percussion tool for performing a chiseling operation on a workpiece with a chisel, the percussion tool comprising:
a housing;
an electric motor positioned within the housing;
a percussion mechanism driven by the motor and including a striker supported for reciprocation relative to the housing along a longitudinal axis; and
a tool holder coupled to the housing and including a rotatable handle having a rod that rotates with the handle within the tool holder, the chisel being securable in and removable from the tool holder, the chisel having a longitudinal groove that is substantially parallel with the longitudinal axis,
wherein when the chisel is secured in the tool holder, the chisel is permitted to axially reciprocate within the tool holder in response to receiving repeated axial impacts from the striker,
wherein the handle is moveable between a first position, in which the rod is received in the groove and the chisel is secured in the tool holder, and a second position, in which the rod is removed from the groove and the chisel is removable from the tool holder, and
wherein when the handle is in the second position, an acute angle is defined between a first reference plane defined by the handle and a second reference plane that is perpendicular to the longitudinal axis, and wherein the acute angle is 10 degrees or less.

2. The percussion tool of claim 1, wherein the rod has a recessed portion and an opposite arcuate portion defined by a circumference of the rod, and wherein in the first position, the arcuate portion is received in the groove, and in the second position, the arcuate portion is removed from the groove and the recessed portion is in facing relationship with the groove.

3. The percussion tool of claim 2, wherein the rod defines an axis of rotation of the handle, wherein the arcuate portion defines an angle along the circumference of the rod with respect to the axis of rotation of the handle, and wherein the angle is 180 degrees or less.

4. The percussion tool of claim 3, wherein the angle is 110 degrees or less.

5. The percussion tool of claim 1, further comprising:
a cylinder portion in which the striker is supported for reciprocation; and
a flange between the cylinder portion and the tool holder,
wherein movement of the chisel within the tool holder toward the percussion mechanism is stopped by the flange.

6. The percussion tool of claim 5, further comprising:
a sleeve slidably supported by at least one of the tool holder or the flange,
wherein the sleeve has a first end with a first end outer diameter that is greater than an inner diameter of the flange, wherein the sleeve has a second end with a second end inner diameter that is less than an outer diameter of the chisel, and
wherein movement of the chisel within the tool holder toward the percussion mechanism is stopped in response to the chisel abutting the second end of the sleeve and the first end of the sleeve abutting the flange.

7. The percussion tool of claim 6, wherein the striker has an impact portion with an impact portion outer diameter, and wherein the second end inner diameter is greater than the impact portion outer diameter, such that the impact portion is configured to pass through the second end of the sleeve.

8. A percussion tool for performing a chiseling operation on a workpiece with a chisel, the percussion tool comprising:
a housing;
an electric motor positioned within the housing;
a percussion mechanism driven by the motor and including a striker supported for reciprocation relative to the housing along a longitudinal axis; and
a tool holder coupled to the housing and including a rotatable handle having a cylindrical rod defining an axis of rotation of the handle, the rod having a recessed portion and an opposite arcuate portion defined by a circumference of the rod,
wherein the chisel is securable in and removable from the tool holder, the chisel having a longitudinal groove that is substantially parallel with the longitudinal axis,
wherein when the chisel is secured in the tool holder, the chisel is permitted to axially reciprocate within the tool holder in response to receiving repeated axial impacts from the striker,
wherein the handle is moveable between a first position, in which the arcuate portion is received in the groove and the chisel is secured in the tool holder, and a second position, in which the arcuate portion is removed from the groove, the recessed portion is in facing relationship with the groove, and the chisel is removable from the tool holder, and
wherein the arcuate portion defines an angle of 110 degrees or less along the circumference of the rod with respect to the axis of rotation of the handle.

9. The percussion tool of claim 8, wherein when the handle is in the second position, an acute angle is defined between a first reference plane defined by the handle and a second reference plane that is perpendicular to the longitudinal axis, and wherein the acute angle is 70 degrees or less.

10. The percussion tool of claim 9, wherein when the acute angle is 10 degrees or less.

11. The percussion tool of claim 8, further comprising:
a cylinder portion in which the striker is supported for reciprocation; and
a flange between the cylinder portion and the tool holder,
wherein movement of the chisel within the tool holder toward the percussion mechanism is stopped by the flange.

12. The percussion tool of claim 11, further comprising:
a sleeve slidably supported by at least one of the tool holder or the flange,
wherein the sleeve has a first end with a first end outer diameter that is greater than an inner diameter of the flange, wherein the sleeve has a second end with a second end inner diameter that is less than an outer diameter of the chisel, and
wherein movement of the chisel within the tool holder toward the percussion mechanism is stopped in response to the chisel abutting the second end of the sleeve and the first end of the sleeve abutting the flange.

13. A percussion tool for performing a chiseling operation on a workpiece with a chisel, the percussion tool comprising:
a housing including a cylinder portion;
a tool holder coupled to the cylinder portion for holding the chisel;
a percussion mechanism including a striker supported for reciprocation in the cylinder portion, the percussion mechanism configured to impart repeated axial impacts to the chisel with the striker; and
a flange between the cylinder portion and the tool holder,
wherein movement of the chisel within the tool holder toward the percussion mechanism is stopped by the flange.

14. The percussion tool of claim 13, further comprising:
a sleeve slidably supported by at least one of the tool holder or the flange,
wherein the sleeve has a first end with a first end outer diameter that is greater than an inner diameter of the flange, wherein the sleeve has a second end with a second end inner diameter that is less than an outer diameter of the chisel, and
wherein movement of the chisel within the tool holder toward the percussion mechanism is stopped in response to the chisel abutting the second end of the sleeve and the first end of the sleeve abutting the flange.

15. The percussion tool of claim 14, wherein the striker has an impact portion with an impact portion outer diameter, and wherein the second end inner diameter is greater than the impact portion outer diameter, such that the impact portion is configured to pass through the second end of the sleeve.

16. The percussion tool of claim 15, wherein the first end of the sleeve has a first end internal diameter that is greater than the outer diameter of the chisel, such that the chisel is configured to pass through the first end of the sleeve.

17. The percussion tool of claim 16, wherein the second end of the sleeve has an outer diameter that is less than the inner diameter of the flange, such that the second end of the sleeve is configured to pass through the flange.

18. The percussion tool of claim 13, wherein the tool holder includes a rotatable handle having a rod that rotates with handle within the tool holder,
wherein the chisel is securable in and removable from the tool holder, the chisel having a longitudinal groove that is substantially parallel with the longitudinal axis,
wherein when the chisel is secured in the tool holder, the chisel is permitted to axially reciprocate within the tool holder in response to receiving repeated axial impacts from the striker, and
wherein the handle is moveable between a first position, in which the rod is received in the groove and the chisel is secured in the tool holder, and a second position, in which the rod is moved out of the groove and the chisel is removable from the tool holder.

19. The percussion tool of claim 18, wherein when the handle is in the second position, an acute angle is defined between a first reference plane defined by the handle and a second reference plane that is perpendicular to the longitudinal axis, and
wherein the acute angle is 10 degrees or less.

20. The percussion tool of claim 18, wherein the rod has a recessed portion and an opposite arcuate portion defined by a circumference of the rod,
wherein in the first position, the arcuate portion is received in the groove, and in the second position, the arcuate portion is removed from the groove and the recessed portion is in facing relationship with the groove, and
wherein the arcuate portion defines an angle of 110 degrees or less along the circumference of the rod with respect to the axis of rotation of the handle.
